(19) United States
(12) Patent Application Publication
(10) Pub. No.: US 2011/0199662 A1
(43) Pub. Date: Aug. 18, 2011

(54) FOCUSING ELEMENT, FOCUSING ELEMENT ARRAY, EXPOSURE DEVICE AND IMAGE FORMING DEVICE

(75) Inventors: Shin YASUDA, Kanagawa (JP); Jiro Minabe, Kanagawa (JP); Katsunori Kawano, Kanagawa (JP); Yasuhiro Ogasawara, Kanagawa (JP); Kazuhiro Hayashi, Kanagawa (JP); Akira Tateishi, Kanagawa (JP)

(73) Assignee: FUJI XEROX CO., LTD., Tokyo (JP)

(21) Appl. No.: 12/871,546

(22) Filed: Aug. 30, 2010

(30) Foreign Application Priority Data
Feb. 17, 2010 (JP) 2010-032574

(51) Int. Cl. G02B 5/32

(52) U.S. Cl. 359/19

(57) ABSTRACT

There is provided a focusing element including: a light-generating element that generates light in a pre-specified wavelength range and emits diffuse light; and a hologram element in a recording layer disposed at a light emission side of the light-generating element, the hologram element being recorded by wavelength multiplexing with light of plural wavelengths selected from the wavelength range of the light-generating element, and the hologram element being illuminated with the diffuse light from the light-generating element and emitting diffracted light that converses at a pre-specified focusing point.

### CROSS-REFERENCE TO RELATED APPLICATION

This application is based on and claims priority under 35 USC 119 from Japanese Patent Application No. 2010-032574 filed on Feb. 17, 2010.

### BACKGROUND

### Technical Field

The present invention relates to a focusing element, a focusing element array, an exposure device and an image forming device.

### SUMMARY

According to an aspect of the invention, there is provided a focusing element including:

a light-generating element that generates light in a pre-specified wavelength range and emits diffuse light; and

a hologram element in a recording layer disposed at a light emission side of the light-generating element, the hologram element being recorded by wavelength multiplexing with light of plural wavelengths selected from the wavelength range of the light-generating element, and the hologram element being illuminated with the diffuse light from the light-generating element and emitting diffracted light that converses at a pre-specified focusing point.

### BRIEF DESCRIPTION OF THE DRAWINGS

Exemplary embodiments of the present invention will be described in detail based on the following figures, wherein:

FIG. 1 is a schematic diagram illustrating an example of structure of an image forming device relating to an exemplary embodiment of the present invention;

FIG. 2 is a schematic perspective diagram illustrating an example of structure of an LED print head relating to the exemplary embodiment of the present invention;

FIG. 3A is a perspective view illustrating a schematic shape of a hologram element;

FIG. 3B is a sectional view of a slow scanning direction of the LED print head;

FIG. 3C is a sectional view of a fast scanning direction of the LED print head;

FIG. 4 is a diagram illustrating a condition in which a hologram is recorded in a hologram recording layer;

FIG. 5A is a diagram illustrating a light emission spectrum of an LED;

FIG. 5B is a diagram illustrating an example of selection of wavelengths to be used in wavelength-multiplexing method;

FIG. 5C is a diagram illustrating another example of selection of wavelengths to be used in wavelength-multiplexing method;

FIG. 6A and FIG. 6B are diagrams illustrating examples of criteria for selecting wavelengths to be used in wavelength-multiplexing method;

FIG. 7A and FIG. 7B are diagrams illustrating a condition in which a hologram is replayed and diffracted light is generated; and

FIG. 8 is an exploded perspective diagram illustrating an example of partial structure of an LED print head in which a hologram element array corresponding with an SLED array is formed.

### DETAILED DESCRIPTION

Herebelow, an example of an embodiment of the present invention is described in detail with reference to the attached drawings.

—Image Forming Device in which LED Print Head is Mounted—

First, an image forming device in which an LED print head relating to the exemplary embodiment of the present invention is mounted is described. In photocopiers, printers and the like that form images by an electrophotography system, as exposure devices that write latent images on photoreceptor drums, LED-type exposure devices that use light-emitting diodes (LEDs) as light sources are becoming usual in place of related art laser ROS-type (raster output scanner) exposure devices. With an LED-type exposure device, a scanning optical system is not needed and a much greater reduction in size than with a laser ROS system is possible. There is a further advantage in that a driving motor for driving a polygon mirror is not needed and mechanical noise is not produced.

An LED-type exposure device is referred to as an LED print head, which is abbreviated to LPH. A related art LED print head includes an LED array in which numerous LEDs are arranged on a long, narrow substrate, and a lens array in which numerous refractive index distribution rod lenses are arranged. In the LED array, the numerous LEDs are arranged to correspond with a number of pixels in a fast scanning direction, for example, 1200 pixels per inch (that is, 1200 dpi). In related art, rod lenses that are SELFOC (registered trademark) lenses or the like are used in the lens array. The lights emitted from the LEDs are condensed by the rod lenses, and upright equimagnified images are focused onto a photoreceptor drum.

LED print heads that use hologram elements instead of rod lenses have been investigated. The image forming device relating to the present exemplary embodiment includes an LED print head that is provided with a hologram element array described hereinafter. In an LPH that uses rod lenses, an optical path distance between end surfaces of the lens array and focusing points (the operating distance) is short, in the order of a few millimetres, and a proportion of the circumference of the photoreceptor drum that is occupied by the exposure device is large. In contrast, an LPH 14 that is provided with a hologram element array has a long operating distance, of the order of a few centimetres, the circumference of the photoreceptor drum is not crowded, and the image forming device as a whole is reduced in size.

In general, in an LPH that uses LEDs that emit incoherent light (non-interfering light), coherence is low, spot blurring (known as chromatic aberration) occurs, and it is not easy to form microscopic spots. In contrast, in the LPH 14 provided with the hologram lens array, incidence angle selectivity and wavelength selectivity of the hologram elements are high, and microscopic spots with sharp outlines are formed on a photoreceptor drum 12.

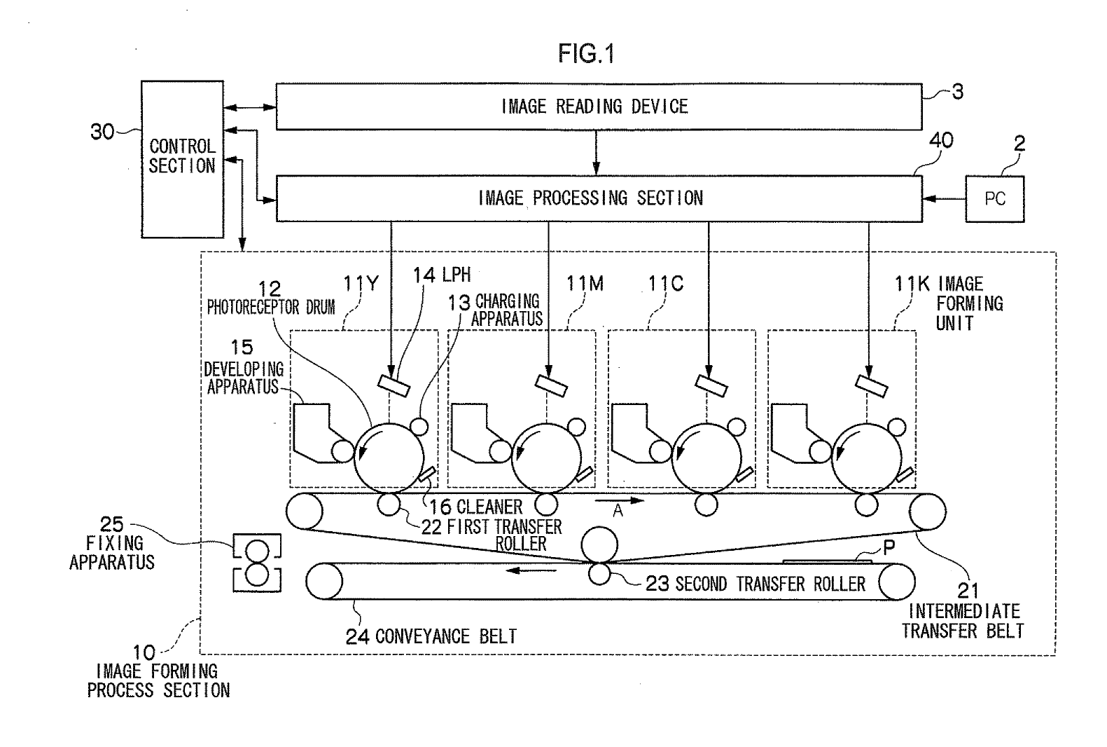

FIG. 1 is a schematic diagram illustrating an example of structure of the image forming device relating to the exemplary embodiment of the present invention. This image forming device is what is known as a tandem-type digital color printer. The image forming device includes an image forming process section 10, a control section 30 and an image processing section 40. The image forming process section 10 serves as an image forming section that performs image formation in accordance with image data of respective colors. The control section 30 controls operations of the image forming device. The image processing section 40 is connected to an image reading device 3 and an external device such as, for example, a personal computer (PC) 2 or the like, and applies predetermined image processing to image data received from these devices.

The image forming process section 10 includes four image forming units 11Y, 11M, 11C and 11K, which are disposed in a line with a constant spacing. The image forming units 11Y, 11M, 11C and 11K form toner images of yellow (Y), magenta (M), cyan (C) and black (K), respectively. The image forming units 11Y, 11M, 11C and 11K may be collectively referred to as image forming units 11 where appropriate.

Each image forming unit 11 includes the photoreceptor drum 12, an charging apparatus 13, the LED print head (LPH) 14, a developing apparatus 15 and a cleaner 16. The photoreceptor drum 12 serves as an image bearing body at which an electrostatic latent image is formed and that bears a toner image. The charging apparatus 13 uniformly charges a surface of the photoreceptor drum 12 to a predetermined potential. The LPH 14 serves as an exposure device that exposes the photoreceptor drum 12 that has been charged by the charging apparatus 13. The developing apparatus 15 develops the electrostatic latent image provided by the LPH 14. The cleaner 16 cleans the surface of the photoreceptor drum 12.

The LPH 14 is a long, narrow print head with a length substantially the same as an axial direction length of the photoreceptor drum 12. The LPH 14 is disposed at the periphery of the photoreceptor drum 12 such that the length direction thereof is aligned with the axial direction of the photoreceptor drum 12. In the present exemplary embodiment, plural LEDs are arranged in an array pattern (row pattern) along the length direction of the LPH 14. Over the LED array, plural hologram elements are arranged in an array corresponding with the plural LEDs.

As described hereinafter, the operating distance of the LPH 14 provided with the hologram element array is long and the LPH 14 is disposed several centimetres away from the surface of the photoreceptor drum 12. Therefore, a width in the circumferential direction of the photoreceptor drum 12 that is occupied by the LPH 14 is small, and crowding of the periphery of the photoreceptor drum 12 is eased.

The image forming process section 10 also includes an intermediate transfer belt 21, first transfer rollers 22, a second transfer roller 23 and a fixing apparatus 25. Toner images of the respective colors that have been formed on the photoreceptor drums 12 of the image forming units 11 are superposedly transferred onto the intermediate transfer belt 21. The first transfer rollers 22 sequentially transfer (first transfer) the color toner images at the image forming units 11 onto the intermediate transfer belt 21. The second transfer roller 23 collectively transfers (second transfers) the superposed toner images that have been transferred onto the intermediate transfer belt 21 onto paper P, which is a recording medium. The fixing apparatus 25 fixes the second-transferred image onto the paper P.

Next, operations of the image forming device described above are described.

First, the image forming process section 10 performs an image processing operation on the basis of control signals such as synchronization signals and the like supplied from the control section 30. At this time, image data inputted from the image reading device 3, PC 2 or the like is subjected to image processing by the image processing section 40, and is provided to the image forming units 11 through an interface.

For example, at the image forming unit 11Y for yellow, the surface of the photoreceptor drum 12 that has been uniformly charged to the predetermined voltage by the charging apparatus 13 is exposed by the LPH 14, which emits light on the basis of the image data provided from the image processing section 40, and an electrostatic latent image is formed on the photoreceptor drum 12. That is, the surface of the photoreceptor drum 12 is fast scanned by the LEDs of the LPH 14 emitting light on the basis of the image data, and is slow scanned by the photoreceptor drum 12 turning. Thus, the electrostatic latent image is formed on the photoreceptor drum 12. The electrostatic latent image that has been formed is developed by the developing apparatus 15 to form a yellow toner image. Similarly, images of the colors magenta, cyan and black are formed at the image forming units 11M, 11C and 11K.

The color toner images formed by the image forming units 11 are sequentially electrostatically attracted by the first transfer rollers 22 and transferred onto the intermediate transfer belt 21 that is turning in the direction of arrow A of FIG. 1 (first transfer). A superposed toner image is formed on the intermediate transfer belt 21. The superposed toner image is conveyed to a region at which the second transfer roller 23 is disposed (a second transfer portion) in accordance with movement of the intermediate transfer belt 21. When the superposed toner image is conveyed to the second transfer portion, paper P is supplied to the second transfer portion to match a timing at which the toner image is conveyed to the second transfer portion.

At the second transfer portion, the superposed toner image is collectively electrostatically transferred onto the paper P conveyed thereto (second transfer) by a transfer electric field formed by the second transfer roller 23. The paper P onto which the superposed toner image has been electrostatically transferred is separated from the intermediate transfer belt 21 and is conveyed to the fixing apparatus 25 by a conveyance belt 24. The unfixed toner image on the paper P that has been conveyed to the fixing apparatus 25 is fixed onto the paper P by being subjected to fixing processing with heat and pressure by the fixing apparatus 25. The paper P on which the fixed image has been formed is then ejected to an ejection tray (not illustrated) provided at an ejection portion of the image forming device.

—LED Print Head (LPH)—

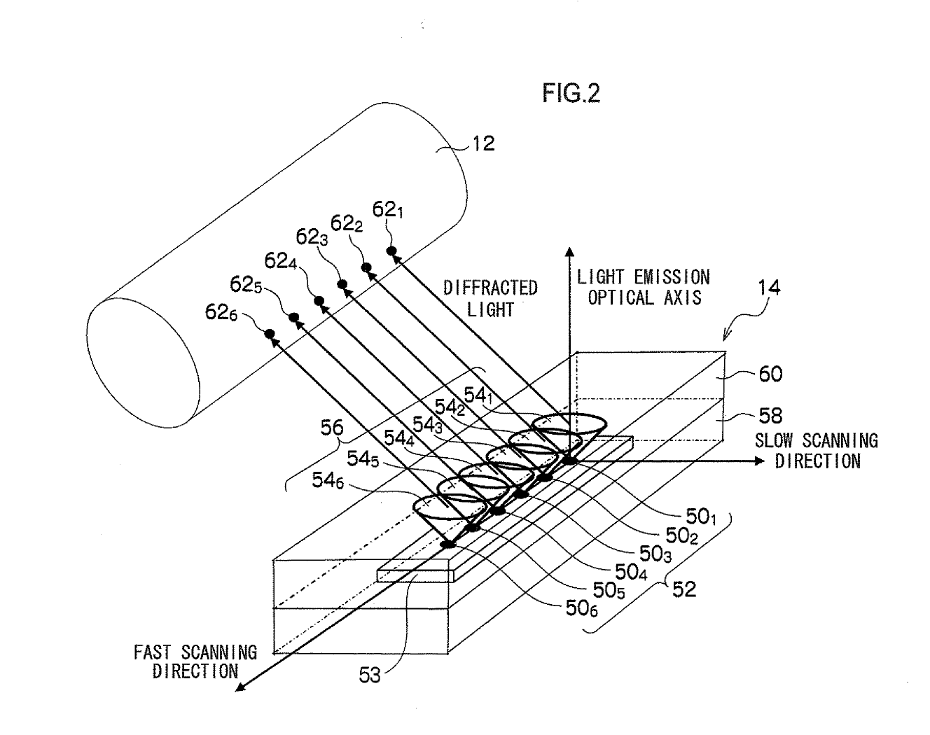

FIG. 2 is a schematic perspective diagram illustrating an example of structure of an LED print head relating to the exemplary embodiment of the present invention. As illustrated in FIG. 2, the LED print head (LPH 14) includes an LED array 52 that includes plural LEDs 50, and a hologram element array 56 that includes plural hologram elements 54 which are disposed in respective correspondence with the plural LEDs 50. In the example illustrated in FIG. 2, the LED array 52 is provided with six LEDs 50₁ to 50₆, and the hologram element array 56 is provided with six hologram elements 54₁ to 54₆. Where it is not necessary to distinguish between individuals, the LEDs 50₁ to 50₆ are referred to as the LEDs 50 and the hologram elements 54₁ to 54₆ are referred to as the hologram elements 54.

The respective plural LEDs 50 are arranged on an LED chip 53. The LED chip 53 on which the plural LEDs 50 are arranged is mounted on a long, narrow LED substrate 58 together with a driving circuit (not illustrated) that drives each of the LEDs 50. The LED chip 53 is positioned such that the LEDs 50 are aligned along the fast scanning direction, and is disposed on the LED substrate 58. Thus, the respective LEDs 50 are arranged along a direction parallel to the axial direction of the photoreceptor drum 12.

The direction of arrangement of the LEDs 50 is the fast scanning direction. The respective LEDs 50 are arranged such that a fast scanning direction spacing (light emission point pitch) between mutually adjacent pairs of the LEDs 50 (light emission points) is a constant spacing. Slow scanning is implemented by turning of the photoreceptor drum 12, and a direction orthogonal to the fast scanning direction is shown as being the slow scanning direction. Hereinafter, the positions at which the LEDs 50 are disposed are referred to where appropriate as light emission points.

Various formats of LED array may be used as the LED array 52, such as an LED array in which the plural LEDs are mounted on a substrate in chip units, or the like. If LED chips on which plural LEDs are arranged are plurally arrayed, the plural LED chips may be arranged in a straight line, and may be arranged M a staggered pattern. Furthermore, two or more LED chips may be arranged in the slow scanning direction. FIG. 2 merely schematically illustrates an LED array 52 in which the plural LEDs 50 are arranged in a one-dimensional pattern on a single LED chip 53.

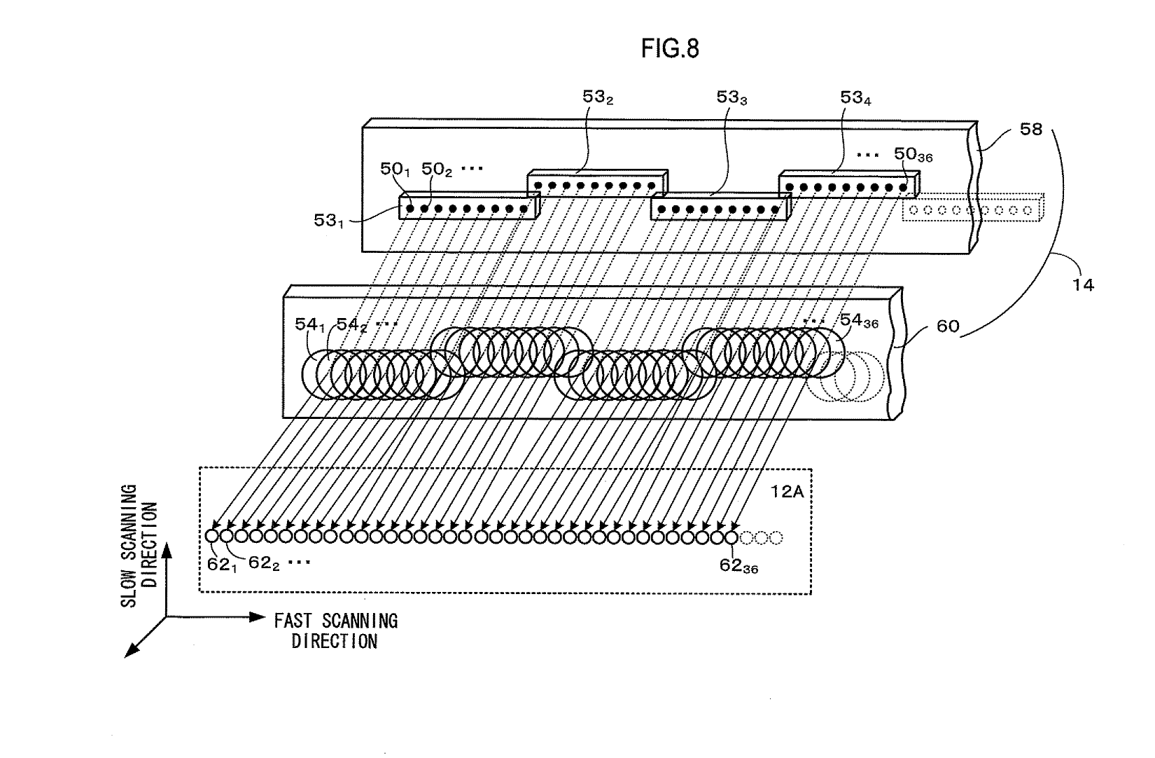

As described hereinafter, in the present exemplary embodiment, a plural number of the LED chips 53 are arranged in a staggered pattern in the LED array 52 (see FIG. 8). That is, the plural LED chips 53 are arranged in one direction so as to be aligned in the fast scanning direction and are arranged in two rows offset by a certain spacing in the slow scanning direction. Even though the plural LEDs 50 are divided between the plural LED chips 53, the respective plural LEDs 50 are arranged such that the fast scanning direction spacing between mutually adjacent pairs of the LEDs 50 is a constant spacing.

An SLED array may be used as the LED array 52, which is structured by plurally arranging SLED chips (not illustrated) on which plural self-scanning LEDs (SLEDs) are arranged such that the LEDs are aligned in the fast scanning direction. On/off switching of the SLED array is implemented by pairs of signal lines, the SLEDs are selectively caused to emit light, and data lines are shared. By using this SLED array, a number of wires on the LED substrate 58 may be kept small.

A hologram recording layer 60 is formed on the LED substrate 58 so as to cover the aforementioned LED chips 53. The hologram element array 56 is formed in the hologram recording layer 60 formed over the LED substrate 58. As described hereinafter, the LED substrate 58 and the hologram recording layer 60 do not need to be in close contact, and may be separated by a predetermined distance with an air layer, a transparent resin layer or the like interposed. For example, the hologram recording layer 60 may be retained by an unillustrated retaining member at a position separated by a predetermined height from the LED substrate 58.

The plural hologram elements 54₁ to 54₆ are formed along the fast scanning direction in correspondence with the plural LEDs 50₁ to 50₆, respectively. The respective hologram elements 54 are arranged such that a fast scanning direction spacing between mutually adjacent pairs of the hologram elements 54 is a spacing substantially the same as the above-mentioned fast scanning direction spacing of the LEDs 50. That is, large diameter hologram elements 54 are formed such that mutually adjacent pairs of the hologram elements 54 overlap with one another. The mutually adjacent pairs of the hologram elements 54 may have differing shapes.

The hologram recording layer 60 is formed of a polymer material capable of permanently recording and retaining a hologram. As this polymer material, a material known as a photopolymer may be used. A photopolymer uses a change in refractive index caused by polymerization of a photopolymerizable monomer to record a hologram.

When the LEDs 50 are caused to generate light, the lights emitted from the LEDs 50 (incoherent light) pass along diverging light, optical paths that spread from the light emission points to the hologram diameters. The light emission of the LEDs 50 causes a state substantially the same as when reference light is illuminated onto the hologram elements 54. As illustrated in FIG. 2, in the LPH 14 provided with the LED array 52 and the hologram element array 56, the lights emitted from each of the six LEDs 50₁ to 50₆ are incident on the corresponding hologram elements 54₁ to 54₆. The hologram elements 54₁ to 54₆ diffract the incident light and generate diffracted light. The diffracted lights generated by the respective hologram elements 54₁ to 54₆ pass away from the optical paths of the diverging lights and are emitted in directions such that the optical axes thereof form angles θ with the light emission optical axes, and are focused in the direction of the photoreceptor drum 12.

The diffracted lights that are emitted converge in the direction of the photoreceptor drum 12, and are focused on the surface of the photoreceptor drum 12 disposed at a focusing plane several centimetres distant. That is, each of the plural hologram elements 54 functions as an optical member that diffracts and focuses the light emitted from the corresponding LED 50 and focuses the light on the surface of the photoreceptor drum 12. At the surface of the photoreceptor drum 12, microscopic spots 62₁ to 62₆ are formed by the diffracted lights so as to be arranged in a row in the fast scanning direction. In other words, the photoreceptor drum 12 is fast scanned by the LPH 14. Herein, where it is not necessary to distinguish between the individual spots, the spots 62₁ to 62₆ are collectively referred to as spots 62.

—Shapes of the Hologram Elements—

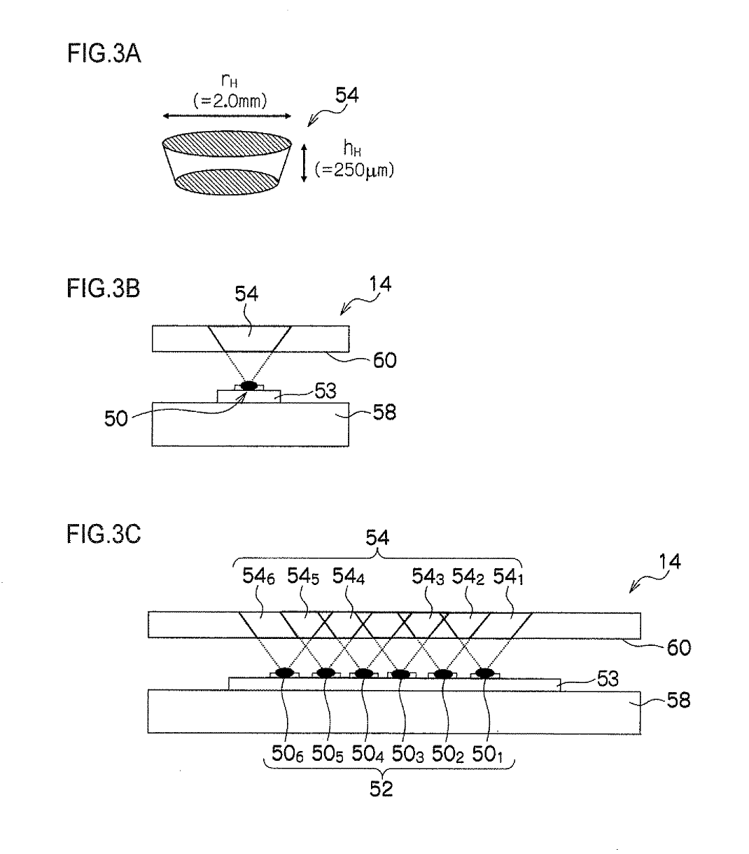

FIG. 3A is a perspective view illustrating a schematic shape of a hologram element, FIG. 3B is a sectional view of the slow scanning direction of the LED print head, and FIG. 3C is a sectional view of the fast scanning direction of the LED print head.

As illustrated in FIG. 3A, each of the hologram elements 54 is a volume hologram, commonly referred to as a thick hologram. As mentioned above, the hologram element has high incidence angle selectivity and wavelength selectivity, controls an emission angle (diffraction angle) of diffracted light with high accuracy, and forms a microscopic spot with a sharp outline. The accuracy of the diffraction angle is higher when the thickness of the hologram is thicker. On the other hand, the thicker the thickness of the hologram, the narrower the wavelength range included in the diffracted light, and the lower the light production efficiency.

In the present exemplary embodiment, in order to improve the light production efficiency, each of the plural hologram elements 54 is recorded by wavelength multiplexing with a plural number of wavelengths that are in the light emission wavelength range of the LEDs 50. The hologram elements 54 recorded by wavelength multiplexing replay the diffracted light and improve light production efficiency for any of the plural wavelengths of light used in the multiplexing recording. Criteria for selection of the wavelengths to be used in the wavelength multiplexing recording are described below.

As illustrated in FIG. 3A and FIG. 3B, each of the hologram elements 54 is formed in a circular truncated cone shape, which has a floor face at a front face side of the hologram recording layer 60 and converges toward the LED 50. Circular truncated cone shape hologram elements are described in this example, but the hologram elements are not to be limited to this shape. For example, shapes such as circular cones, elliptical cones, elliptical truncated cones and the like are possible. The diameter of the circular truncated cone shape hologram elements 54 is largest at the floor face, and the diameter of this circular floor face is a hologram diameter r_{H}.

Each of the hologram elements 54 has a hologram diameter r_{H} larger than the fast scanning direction spacing of the LEDs 50. For example, the fast scanning direction spacing of the LEDs 50 is 30 μm, the hologram diameter r_{H} is 2 mm, and the hologram thickness h_{H} is 250 μm. Therefore, as illustrated in FIG. 2 and FIG. 3C, the mutually adjacent pairs of the hologram elements 54 are formed so as to greatly overlap with one another. The plural hologram elements 54 are multiplexingly recorded by, for example, shift multiplexing method with a spherical reference wave.

Each of the plural LEDs 50 is disposed on the LED substrate 58 with a light emission face oriented toward the front face side of the hologram recording layer 60 so as to emit light at the corresponding hologram element 54. A light emission optical axis of the LED 50 passes close to the center of the corresponding hologram element 54 (the axis of symmetry of the circular truncated cone), and is oriented in a direction orthogonal to the LED substrate 58. As illustrated, the light emission optical axis is orthogonal to both of the aforementioned fast scanning direction and slow scanning direction.

Although not illustrated, the LPH 14 is retained by the retaining member, such as a housing, a holder or the like, and is attached at a predetermined position in the image forming unit 11, such that the diffracted lights emitted by the hologram elements 54 are emitted in the direction of the photoreceptor drum 12. The LPH 14 may be structured so as to be moved in the optical axis direction of the diffracted light by an adjustment component, such as an adjustment screw (not illustrated) or the like. Focusing positions according to the hologram elements 54 (the focusing plane) are adjusted by the adjustment component so as to be positioned at the surface of the photoreceptor drum 12. Furthermore, a protective layer may be formed on the hologram recording layer 60, of a cover glass, a transparent resin or the like. The adherence of undesired matter is prevented by this protective layer.

—Hologram Recording Method—

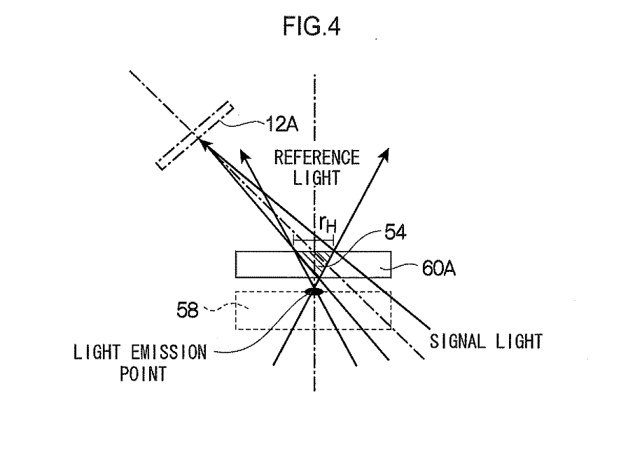

Next, a hologram recording method is described. FIG. 4 is a diagram illustrating a condition in which the hologram 54 is formed in the hologram recording layer, that is, a condition in which a hologram is recorded in a hologram recording layer. The photoreceptor drum 12 is not illustrated; only a surface 12A, which is the focusing plane, is illustrated. A hologram recording layer 60A is the recording layer before the hologram elements 54 are formed, and is distinguished from the hologram recording layer 60 in which the hologram elements 54 have been formed by appending the reference symbol A.

As illustrated in FIG. 4, coherent light passing along the optical path of the diffracted light to be focused on the surface 12A is illuminated on the hologram recording layer 60A to serve as signal light. At the same time, coherent light that passes along the optical path of the diverging light, spreading from the light emission point to the predetermined hologram diameter r_{H} when passing through the hologram recording layer 60A, is illuminated on the hologram recording layer 60A to serve as reference light. Laser light sources such as semiconductor lasers or the like are used for the illumination of the coherent lights.

The signal light and the reference light are illuminated onto the hologram recording layer 60A from the same side (the side at which the LED substrate 58 is to be disposed). An interference pattern (intensity distribution) that is obtained by interference between the signal light and the reference light is recorded through the thickness direction of the hologram recording layer 60A. Thus, the hologram recording layer 60 in which the hologram elements 54 are formed is obtained. Each hologram element 54 is a volume hologram recording the intensity distribution of the interference pattern in surface directions and the thickness direction. This hologram recording layer 60 is installed over the LED substrate 58 on which the LED array 52 is mounted, and thus the LPH 14 is fabricated.

In the present exemplary embodiment, in order to improve light production efficiency, each of the plural hologram elements 54 is recorded by wavelength multiplexing with plural wavelengths that are in the light emission wavelength range of the LEDs 50. That is, a plural number of volume holograms are multiplexingly recorded, being recorded by interference between signal lights (spherical waves) of different wavelengths and reference lights (spherical waves) at matching positions (internal volumes) of the hologram recording layer 60A. Hologram recording conditions apart from the wavelengths, such as the optical axis directions and spreading angles of the signal lights and reference lights and the like, are the same.

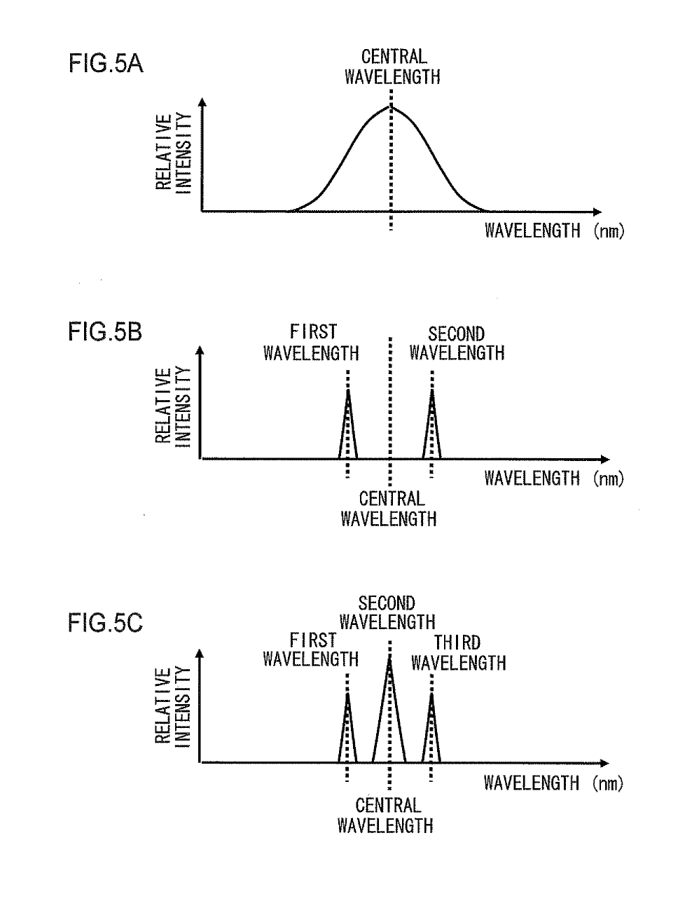

FIG. 5A is a diagram illustrating a light emission spectrum of an LED, FIG. 5B is a diagram illustrating an example of selection of wavelengths to be used in wavelength-multiplexing method, and FIG. 5C is a diagram illustrating another example of selection of wavelengths to be used in wavelength-multiplexing method. As illustrated in FIG. 5A, a light emission spectrum of the LED 50 that is an incoherent light source (a diffuse light source) has a distribution close to a Gaussian distribution, symmetrically spreading to left and right about a peak light emission wavelength. Thus, plural wavelengths that are in this light emission wavelength range may be selected as wavelengths for multiplexed recording of the hologram elements 54. The peak light emission wavelength at the center is referred to as a central wavelength.

For example, as illustrated in FIG. 5B, wavelength multiplexing may be performed using two wavelengths that are at symmetrical positions in the light emission spectrum of the LEDs 50 relative to the central wavelength. The wavelength at the shorter wavelength side of the central wavelength is referred to as a first wavelength and the wavelength at the longer wavelength side of the central wavelength is referred to as a second wavelength. Provided the wavelengths are at symmetrical positions (an even number of wavelengths that are symmetrical), the number of wavelengths is not to be limited to two wavelengths and may be increased to four wavelengths or six wavelengths.

Further, as illustrated in FIG. 5C, wavelength multiplexing may be performed with a total of three wavelengths, using the central wavelength of the light emission spectrum of the LEDs 50 and two wavelengths that are at symmetrical positions relative to the central wavelength. The wavelength at the shorter wavelength side of the central wavelength is referred to as the first wavelength, the wavelength at the longer wavelength side of the central wavelength is referred to as the second wavelength, and the central wavelength is referred to as a third wavelength. Similarly to the case illustrated in FIG. 5B, this is not to be limited to three wavelengths. When wavelength multiplexing is performed with a total of three wavelengths, the central wavelength and two wavelengths symmetrical thereabout, as illustrated in FIG. 5C, the wavelength of the peak intensity of the incoherent light (the central wavelength) contributes to diffraction. Therefore, light use efficiency is increased relative to when wavelength multiplexing is performed using two wavelengths as illustrated in FIG. 5B.

The selection of wavelengths to be used in multiplexing recording is carried out in accordance with various criteria. For example, because the hologram is a diffraction grating, a grating pitch will vary with environmental conditions such as temperature changes and the like. As a result, diffraction efficiency changes in accordance with the environment. Thus, light production efficiency varies with environmental changes. Taking such changes into account, it is preferable to select the wavelengths to be used in wavelength-multiplexing method with regard to a number of considerations:

1) Forming sharp focused spots;
2) obtaining high light production efficiency; and
3) Suppressing variations in light production efficiency that are caused by environmental changes.

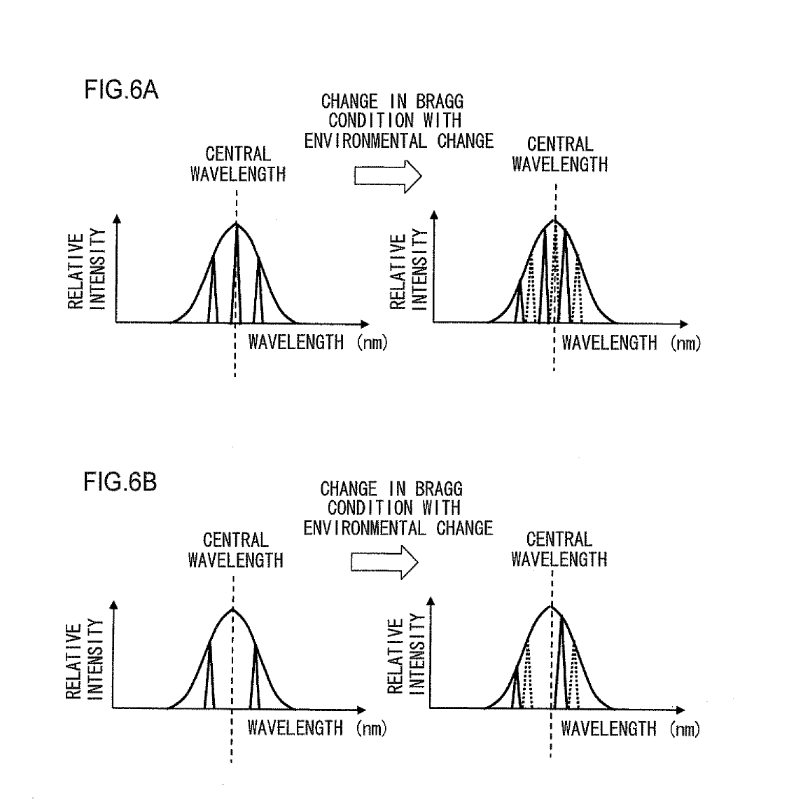

FIG. 6A and FIG. 6B are diagrams illustrating examples of criteria for selecting wavelengths to be used in wavelength-multiplexing method. In regard to the consideration “3) Suppressing variations in light production efficiency that are caused by environmental changes”, it is better to perform wavelength multiplexing using two wavelengths as illustrated in FIG. 5B. As illustrated in FIG. 6A and FIG. 6B, in response to an environmental change such as a temperature change or the like, the wavelength range of diffracted light from a hologram (diffractable light) changes from the range shown by dotted lines toward the range shown by solid lines as indicated by the arrow. As mentioned earlier, this is because the grating pitch of the hologram varies with environmental changes such as temperature changes and the like, and wavelengths that satisfy the Bragg condition change.

As illustrated in FIG. 6A, when wavelength multiplexing is performed using the central wavelength, the diffraction efficiency of the central wavelength varies with environmental changes and the overall diffraction efficiency tends to vary with environmental changes. In contrast, as illustrated in FIG. 6B, if wavelength multiplexing is performed using symmetrical wavelengths about the central wavelength, then when the diffraction efficiency of the short wavelength light decreases in response to an environmental change, the diffraction efficiency of the long wavelength light increases. Similarly, the diffraction efficiency of the short wavelength light increases if the diffraction efficiency of the long wavelength light decreases in response to an environmental change. Therefore, variations in total diffraction efficiency that are caused by environmental changes are suppressed, and intensity variations due to environmental changes are suppressed.

For the reason described above, in consideration of “3) Suppressing variations in light production efficiency that are caused by environmental changes”, it is better to perform wavelength multiplexing using two wavelengths as illustrated in FIG. 5B. However, if the spectrum near the central wavelength is sufficiently broad, then if particular conditions are satisfied, such as changes in the pitch of the diffraction grating in an expected range of temperature changes being considered sufficiently small and the like, changes in the diffraction efficiency will be kept sufficiently small. Thus, as illustrated in FIG. 5C, wavelength multiplexing may be performed with wavelengths that include the central wavelength.

—Hologram Replay Method—

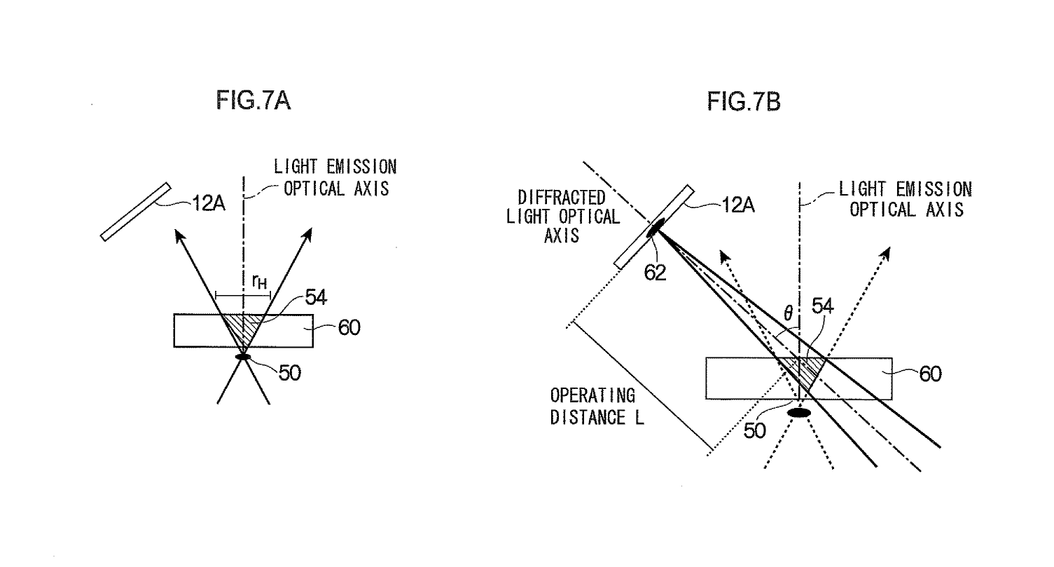

Next, a hologram replay method is described. FIG. 7A and FIG. 7B are diagrams illustrating a condition in which diffracted light from a hologram element is generated, that is, a condition in which a hologram recorded in the hologram recording layer is replayed and diffracted light is generated. As illustrated in FIG. 7A, when the LED 50 is caused to generate light, the light emitted from the LED 50 passes along the diverging light optical path, spreading from the light emission point to the hologram diameter r_{H}. Thus, because of the light emission of the LED 50, the hologram is in substantially the same condition as when the reference light was illuminated on the hologram element.

As illustrated in FIG. 7B, when the reference light is illuminated as shown by the broken lines, light the same as the signal light is replayed from the hologram element 54 as shown by the solid lines, and is emitted as diffi acted light. The emitted diffracted light converges and is focused on the surface 12A of the photoreceptor drum 12 at the operating distance of several centimetres. Thus, the spot 62 is formed on the surface 12A. The surface 12A is schematically illustrated in FIG. 7B; given that the hologram diameter r_{H} is a number of millimetres and the operating distance L is a number of centimetres, the surface 12A is at a much further distant position than illustrated. Accordingly, the hologram element 54 is not formed as a circular cone as illustrated but as a circular truncated cone as illustrated in FIG. 3A.

As illustrated in FIG. 2, the six spots 62₁ to 62₆ are formed on the photoreceptor drum 12, aligned in a row in the fast scanning direction, in correspondence with the LEDs 50₁ to 50₆ of the LED array 52. The six spots 62₁ to 62₆ are focusing spots into which the diffracted lights from the hologram elements 54₁ to 54₆ are focused. In particular, volume holograms provide high incidence angle selectivity and wavelength selectivity, and high diffraction efficiency. Therefore, background noise is reduced, signal light is accurately replayed, and microscopic spots with sharp outlines (focused light points) are formed on the surface 12A.

In the present exemplary embodiment, in order to improve light production efficiency, the plural hologram elements 54 are recorded by wavelength multiplexing with plural wavelengths that are in the wavelength light emission wavelength range of the LEDs 50. The hologram elements 54 recorded by wavelength multiplexing replay diffracted lights that are focused to the same focusing points in response to light of any of the plural wavelengths used in the wavelength multiplexing. The light production efficiency is improved, and light amounts of the plural spots 62 formed on the surface of the photoreceptor drum 12 (that is, diffracted light intensities) are also improved.

When the number of wavelengths is larger, the light usage efficiency increases. However, when the number of wavelengths increases, the degree of multiplexing that is the number of the multiplexed holograms increases, and therefore a larger dynamic range is required of the recording medium. Thus, the number of wavelengths is determined by a required light usage efficiency and the dynamic range of a recording medium.

—Concrete Structure of the LPH—

Next, more specific structure of the LPH is described. An example in which the six LEDs 50₁ to 50₆ are arranged in a single row is schematically illustrated in FIG. 2. In a practical image forming device, however, thousands of the LEDs 50 will be arranged, depending on the fast scanning direction resolution. For example, describing an SLED array as an example, 128 LEDs are arranged with a spacing of 1200 spi (spots per inch) on each of SLED chips, and 58 of the SLED chips are arranged in a straight row to constitute the SLED array, such that the SLEDs are aligned in the fast scanning direction. Put another way, in an image forming device with a resolution of 1200 dpi, 7,424 of the SLEDs are arranged with a spacing of 21 μm. In correspondence with these 7,424 SLEDs, 7,424 of the spots 62 are formed on the photoreceptor drum 12 so as to be aligned in a row in the fast scanning direction.

FIG. 8 is an exploded perspective diagram illustrating an example of partial structure of an LED print head in which a hologram element array corresponding with an SLED array is formed. The exploded perspective diagram of FIG. 8 more concretely illustrates the structure of the LPH that is schematically illustrated in FIG. 2, and is closer to a structure to be used in a practical image forming device. Where SLEDs are used instead of LEDs, they are referred to as SLEDs 50, with the same reference numeral applied as to the LEDs 50. Similarly, the SLED chips are referred to as SLED chips 53, with the same reference numeral applied.

As described above, in the LPH 14 of a practical image forming device, several thousand of the SLEDs are arranged in accordance with the fast scanning direction resolution. The LPH 14 illustrated in FIG. 8 includes the LED substrate 58 on which the LED array 52 is mounted and the hologram recording layer 60 in which the plural hologram elements 54 are formed. The LED array 52 is an SLED array in which the plural SLED chips 53 are arranged in a staggered pattern of two rows.

In the exploded perspective diagram illustrated in FIG. 8, as a portion of the LPH 14 that is close to a practical structure, a state is illustrated in which four of the SLED chips 53₁ to 53₄ are arranged in the staggered pattern of two rows. In each of the SLED chips 53₁ to 53₄, nine of the SLEDs 50 are arranged in a one-dimensional pattern with a predetermined spacing. Each of the four SLED chips 53₁ to 53₄ is arranged such that the direction of arrangement of the SLEDs 50 is aligned with the fast scanning direction.

The SLED chips 53 of the first row and the SLED chips 53 of the second row are disposed to be offset into the two rows along the fast scanning direction (that is, in a staggered pattern). That is, in the first row of the LED array 52, the SLED chip 53₁ and SLED chip 53₃ are disposed to be mutually adjacent, and in the second row of the LED array 52, the SLED chip 53₂ and SLED chip 53₄ are disposed to be mutually adjacent. Thus, in the example illustrated in FIG. 8, a total of 36 of the SLEDs 50 (SLEDs 50₁ to 50₃₆) shown arranged in two rows.

In correspondence with the 36 SLEDs 50, 36 of the hologram elements 54₁ to 54₃₆ with positions and shapes specified in advance are formed. At the surface 12A of the photoreceptor drum 12, 36 of the spots 62₁ to 62₃₆ are formed in a row with a predetermined spacing along the fast scanning direction, in respective correspondence with the 36 SLEDs 50₁ to 50₃₆. In a practical image forming device, several thousand of the spots 62 are formed in correspondence with several thousand of the SLEDs 50.

### Other Variant Examples

In the above descriptions, an example is described that includes an LED print head provided with plural LEDs. However, other light-generating elements may be used instead of LEDs, such as electroluminescent elements (EL), laser diodes (LD) or the like. The hologram elements are designed in accordance with the characteristics of the light-generating elements and unwanted exposure with incoherent light is prevented. Thus, similarly to when LDs that emit coherent light are used as the light-generating elements, microscopic spots with sharp outlines are formed even when LEDs, ELs or the like that emit incoherent light are used as the light-generating elements.

In the above descriptions, an example has been described in which the plural hologram elements are multiplexingly recorded by spherical wave shift multiplexing. However, the plural hologram elements may be multiplexingly recorded by another multiplexing system, provided the multiplexing system provides the desired diffracted lights. Further, plural kinds of multiplexing system may be combined. As other multiplexing systems, the following may be mentioned: angle multiplexing recording that records with the incidence angle of the reference light being altered; wavelength multiplexing recording that records with the wavelength of the reference light being altered; phase multiplexing recording that records with the phase of the reference light being altered; and the like.

In the above descriptions, it is described that the image forming device is a tandem-type digital color printer and that the exposure device that exposes the photoreceptor drum at each image forming unit is an LED print head. However, it is sufficient that an image forming device is one at which images are formed by imagewise exposure of a photosensitive image recording medium by an exposure device, and the above application example is not to be limiting. For example, the image forming device is not to be limited to an electrophotography-system digital color printer. The exposure device of the present invention may also be installed in silver salt-based image forming devices, writing devices for optically written electronic paper, and the like. Moreover, a photosensitive image recording medium is not to be limited to the photoreceptor drum. The exposure device relating to the above-described application example may also be applied to exposure of sheet-form photoreceptors, photographic photosensitive materials, photoresists, photopolymers and so forth.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to are suited to the particular use contemplated. It is intended that the scope of the invention be defined by the following claims and their equivalents.

What is claimed is:

1. A focusing element comprising:
a light-generating element that generates light in a pre-specified wavelength range and emits diffuse light; and
a hologram element in a recording layer disposed at a light emission side of the light-generating element, the hologram element being recorded by wavelength multiplexing with light of a plurality of wavelengths selected from the wavelength range of the light-generating element, and the hologram element being illuminated with the diffuse light from the light-generating element and emitting diffracted light that converses at a pre-specified focusing point.

2. The focusing element according to claim 1, wherein the plurality of wavelengths recorded in the wavelength multiplexing include wavelengths at positions at a short wavelength side and a long wavelength side of the wavelength range that are substantially symmetrical about a central wavelength.

3. The focusing element according to claim 1, wherein the plurality of wavelengths recorded in the wavelength multiplexing include a central wavelength of the wavelength range.

4. A focusing element array in which a plurality of focusing elements according to claim 1 are arranged in one of a one-dimensional arrangement or a two-dimensional arrangement.

5. An exposure device comprising a plurality of focusing elements according to claim 1,
wherein the plurality of focusing elements are arranged in one of a one-dimensional arrangement or a two-dimensional arrangement, such that the diffracted lights emitted from each of the plurality of focusing elements converge at a pre-specified operating distance and the focusing points of the diffracted lights emitted from each of the plurality of focusing elements are aligned in a pre-specified direction.

6. An image forming device comprising:
an exposure device according to claim 5; and
a photoreceptor that is disposed apart from the exposure device by the operating distance, and on which an image is written by the exposure device in accordance with image data, being fast-scanned in the pre-specified direction in which the focusing points are aligned.
